(19) United States
(12) Patent Application Publication
(10) Pub. No.: US 2026/0160386 A1
(43) Pub. Date: Jun. 11, 2026

(54) DEVICE FOR PROTECTING A HYDROGEN TANK OF AN AIRCRAFT

(71) Applicant: Airbus Operations SAS, TOULOUSE (FR)

(72) Inventors: Jerome MILLIERE, TOULOUSE (FR); Andrea ROMERO HERNANDEZ, TOULOUSE (FR)

(21) Appl. No.: 19/180,836

(22) Filed: Apr. 16, 2025

(30) Foreign Application Priority Data
Apr. 30, 2024 (FR) FR2404488

(51) Int. Cl. F17C 1/04; F17C 13/12

(52) U.S. Cl. CPC F17C 1/04; F17C 13/12; F17C 2205/0332; F17C 2221/012; F17C 2225/035

(57) ABSTRACT

A device for protecting a hydrogen tank, in particular for an aircraft, comprising an external envelope delimiting an internal volume, and an extinguishing agent, preferably in the gas phase, in the internal volume, the external envelope being provided with at least one pressure relief valve, to release the at least one extinguishing agent when a pressure prevailing in the internal volume is greater than a threshold value, and the external envelope being shaped to be installed in a fuselage of the aircraft.

### CROSS-REFERENCES TO RELATED APPLICATIONS

This application claims the benefit of French Patent Application Number FR2404488 filed on Apr. 30, 2024, the entire disclosure of which is incorporated herein by way of reference.

### FIELD OF THE INVENTION

The present invention relates to a device for protecting a hydrogen tank, in particular for an aircraft.

### BACKGROUND OF THE INVENTION

To reduce the climate impact of aviation, the Applicant has developed aircraft designs with hydrogen-powered engines. This type of propulsion requires specific equipment, in particular one or more tanks containing hydrogen, preferably in liquid form and at cryogenic temperature, in order to increase its density and reduce the volume required to store it.

However, additional considerations must be taken into account due to the presence of hydrogen in the aircraft. Thus, a reduction in hydrogen leaks is sought.

The aim of the invention is to at least partially overcome these drawbacks.

### SUMMARY OF THE INVENTION

For this purpose, a device is proposed for protecting a hydrogen tank, in particular for an aircraft, the device comprising an external envelope delimiting an internal volume, and an extinguishing agent, preferably in the gas phase, in said internal volume, the external envelope being provided with at least one pressure relief valve, to release said at least one extinguishing agent when a pressure prevailing in the internal volume is greater than a threshold value, and the external envelope being shaped to be installed in a fuselage of an aircraft.

The device according to the present invention thus helps to considerably reduce risk since, in the event of an accident, the extinguishing agent is released by the pressure relief valve and reduces the concentrations of dioxygen and dihydrogen. Furthermore, the extinguishing agent also acts against other sources of fire outbreaks, such as an electric fire outbreak for example. Moreover, the shape of the external envelope, fitted specifically to an aircraft, makes the device according to the present invention perfectly suited to protecting hydrogen tanks in the event of an impact by preventing the tank from colliding with structural components of the aircraft and absorbing part of the energy of the impact.

According to another aspect, the external envelope comprises a curved portion intended to be placed against a lower portion of the fuselage of the aircraft and to follow the contour thereof.

According to another aspect, the external envelope comprises a flat portion intended to be in contact with a floor of the fuselage of the aircraft.

According to another aspect, the external envelope has, when in the installed position in the aircraft, a thickness equal to a center-to-center distance between two consecutive frames between which the protective device is intended to be installed.

According to another aspect, the external envelope comprises at least one filling port for extinguishing agent.

Advantageously, said at least one filling port is arranged on the external envelope so as to be accessible when in the installed position in the aircraft.

Advantageously, said at least one pressure relief valve is arranged on the external envelope so as to be accessible when in the installed position in the aircraft.

According to another aspect, the threshold pressure is between 2.5*10⁵ Pa and 5*10⁵ Pa, preferably 3*10⁵ Pa.

According to another aspect, said extinguishing agent is at a pressure between 10⁵ Pa and 2*10⁵ Pa, preferably 1.5*10⁵ Pa.

According to another aspect, the external envelope is made of flexible and/or deformable material, so that the internal volume is variable and dependent on the pressure of the gases contained in the envelope.

The invention also relates to an aircraft, comprising a fuselage having a structure provided with a set of annular frames, the aircraft also comprising at least one hydrogen tank and at least one protective device as described above arranged beneath said at least one hydrogen tank, when the fuselage is in the horizontal position.

According to another aspect, the aircraft comprises at least one protective device as described above, the curved portion of which rests on at least one of the annular frames of the fuselage portion.

According to another aspect, the external envelope has a thickness equal to a center-to-center distance between two consecutive frames between which the protective device is installed.

According to another aspect, the aircraft comprises at least a first protective device and a second protective device each arranged under said at least one hydrogen tank, when the fuselage is in the horizontal position, the extinguishing agent of the first protective device being different from the extinguishing agent of the second protective device.

### BRIEF DESCRIPTION OF THE DRAWINGS

Other features, details and advantages will appear from reading the detailed description below, and from analyzing the attached drawings, in which:

FIG. 1 is a schematic perspective view of a protective device for a hydrogen tank of a hydrogen-powered aircraft, according to the present invention.

FIG. 2 is a schematic perspective view of a portion of the fuselage of an aircraft, comprising two hydrogen tanks and a plurality of protective devices from FIG. 1.

FIG. 3 is a schematic view of a cross-section of the fuselage portion in FIG. 2.

FIG. 4 is a schematic view of a cross-section of the fuselage portion in FIG. 3, after collision with a surface (ground, water).

### DETAILED DESCRIPTION OF THE PREFERRED EMBODIMENTS

The examples and the related conditions detailed here are mainly intended to help the reader understand the principles of the present invention and not to limit its scope to these specific examples and conditions. It will be understood that a person skilled in the art can conceive of various arrangements which, although not explicitly described or represented here, nevertheless embody the principles of the present invention and are included in its spirit and scope.

Furthermore, to facilitate understanding, the following description may describe relatively simplified implementations of the present invention. As a person skilled in the art will understand, other implementations of the present invention may be of greater complexity.

In some cases, examples of modifications of the present invention may also be presented. This is done simply as an aid to understanding, and again not to define the scope or establish the limits of the present invention. These modifications are not an exhaustive list, and a person skilled in the art may make other modifications while remaining within the scope of the present invention.

Furthermore, all the statements below relating to the principles, aspects and implementations of the present invention, as well as the specific examples thereof, aim to encompass both the structural and functional equivalents thereof, whether they are currently known or developed in the future.

As can be seen from the figures, the subject matter of the invention is a protective device 1 for at least one hydrogen tank. The invention also relates to an aircraft 2, a fuselage 3 of which is provided with at least one protective device 1.

“Hydrogen tank” means a container for storing fluid dihydrogen, H2, in the gas phase, and/or preferably liquid phase, in order to increase its density and reduce the volume required to store it. A cryogenic storage temperature is preferred.

The figures show a first hydrogen tank, denoted 4, and a second hydrogen tank, denoted 5, clearly in a non-limiting manner. In the figures, each of the tanks 4, 5 has the shape of an elongated cylinder of axis A4, A5. The axes A4, A5 are preferably arranged parallel to the longitudinal axis A of the fuselage of the aircraft.

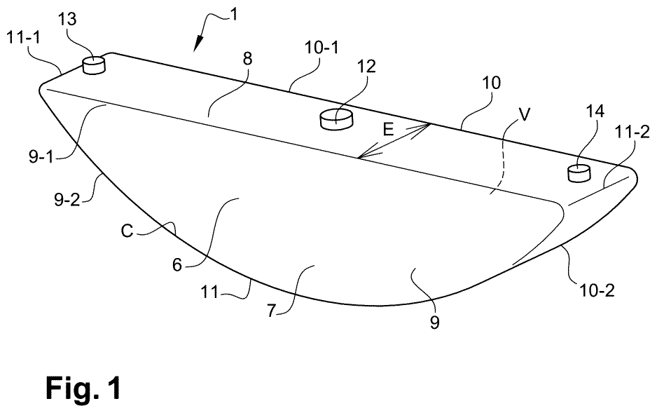

The protective device 1 is described in detail below, more particularly with reference to FIG. 1.

As can be seen in this figure, the protective device 1 comprises an external envelope 6 delimiting an inner volume V. Preferably, the external envelope is made of flexible material, such as for example latex, canvas, or polyethylene.

The flexible envelope is almost flat when unfilled and pressurized with the gas that will be used for extinguishing, allowing easy transportation and easy installation in the aircraft, with inflation being carried out after installation in the aircraft.

The envelope 6 is shaped to be seated in the fuselage 3 of the aircraft 2. In other words, the shape of the device 1 is adjusted for the aircraft 2, as detailed below.

The shape of the envelope 6 once installed in the fuselage 3 and filled with the extinguishing agent is described below.

The general shape of the envelope 6 is a flat truncated cylinder including a curved portion 7 and a flat portion 8.

The curved portion 7 is delimited by two panels 9, 10, preferably identical, spaced apart and facing each other. Each panel 9, 10 comprises a rectilinear edge 9-1, 10-1, and a circularly arcuate edge 9-2, 10-2 of contour C. The curved portion 7 is also delimited by a bottom 11 joining the panels 9, 10 and integral with two opposite rectilinear edges 11-1, 11-2 of the flat portion 8.

The flat portion 8 is a rectangle with edges that coincide with the edges 9-1, 10-1 of the panels 9 and 10 and the edges 11-1, 11-2 of the bottom 11. The thickness of the device 1 is denoted E and corresponds to the length of the edges 11-1, 11-2.

The device 1 also comprises at least one filling port 12 formed in the envelope 6. Preferably, each port 12 is arranged on the envelope 6 at a location such that it is accessible when in the installed position on the aircraft, as explained in greater detail below. In FIG. 1, the device 1 comprises a port 12 arranged substantially at the center of the flat portion 8.

The device 1 also comprises at least one safety valve, or pressure relief valve. Preferably, each valve is arranged on the device 1 at a location such that it is accessible when in the installed position on the aircraft, as explained in greater detail below. In FIG. 1, the device 1 comprises two pressure relief valves, denoted 13 and 14, arranged respectively near the middle of the opposite edges 11-1, 11-2.

It will be noted that the pressure relief valves are the outlets through which the extinguishing gas will be released, as explained below. Their number and positions are defined in order to ensure optimum release of the extinguishing gas and optimum filling of the zone around the tanks.

The internal volume V is filled with an extinguishing agent, in powder form, or preferably in gas phase. The extinguishing agent is chosen from the following non-exhaustive list: the family of halons, or an inert gas, such as helium, dinitrogen, or Inergen IG-541, for example.

The extinguishing agent is stored in the internal volume V at an absolute pressure of between 1 BarA (10⁵ Pa) and 2 BarA, preferably 1.5 BarA.

Each pressure relief valve 13, 14 is designed to open at a pressure greater than or equal to a threshold value, between 2.5 and 5 BarA, preferably 3 BarA.

Thus, under normal conditions of use, the valve is closed, while, if an impact occurs, the device 1 is compressed, which increases its internal pressure to the threshold value, whereupon the valve opens and the extinguishing agent is released.

The presence of the extinguishing agent acts by expelling oxygen and replacing it with the extinguishing gas. If, despite the presence of the protective devices 1, the tank is still damaged and a dihydrogen leak occurs, then the concentration of dioxygen is drastically reduced, which reduces not only the risks related to hydrogen, but also the risks of other fires starting, such as an electrical fire for example.

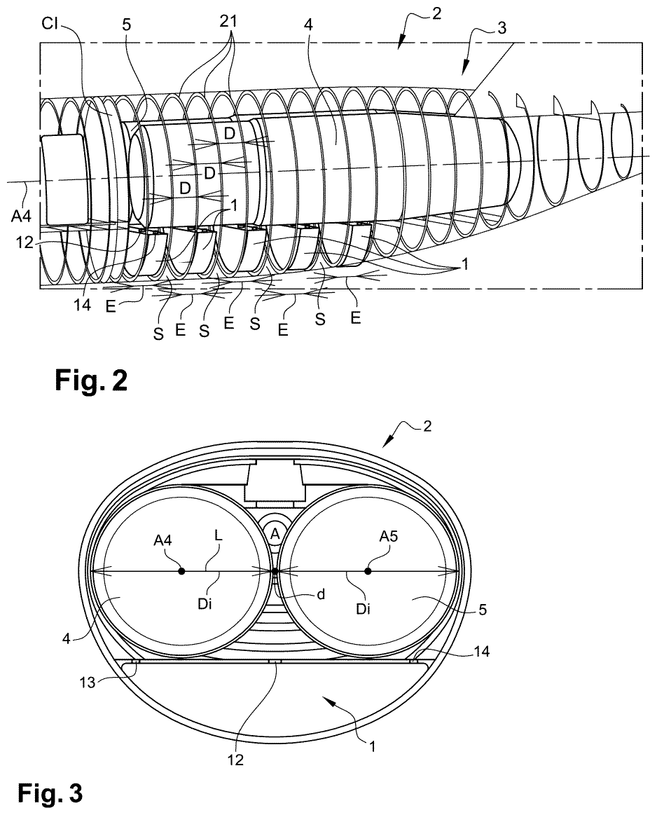

The aircraft 2 equipped with protective devices 1 is described below in detail with reference to FIGS. 2 to 4. These figures illustrate a portion of the fuselage 3, for example the rear portion, forming for example a non-pressurized compartment, of the aircraft 2, behind a cabin portion, from which it is separated by a partition CI (visible in FIG. 2).

As shown in these figures, the fuselage 3 comprises a set of frames 21. The frames 21 are annular elements, preferably concentric, of axis A corresponding to the longitudinal axis of the aircraft. The frames 21 are regularly spaced apart by a distance denoted D.

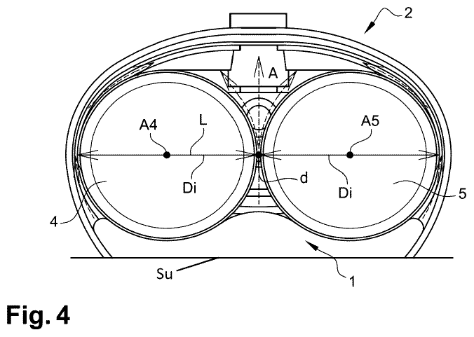

As indicated above, in the embodiment illustrated, the fuselage 3 comprises the first and second cylindrical hydrogen tanks 4, 5. The tanks are arranged so that their longitudinal axes A4, A5 are parallel to the axis A. A transverse distance consisting of the sum of the two diameters Di of the tanks 4, 5 and of the shortest distance d between them is denoted L (lengths shown in FIGS. 3 and 4).

As illustrated in FIG. 2, the fuselage 3 comprises a plurality of protective devices 1 (five devices in FIG. 2) arranged under the hydrogen tanks 4, 5 of the aircraft 2 in a position in which the aircraft is resting on the ground. This position corresponds to a horizontal position of the fuselage 3.

In FIG. 2, each device 1 is seated between two consecutive frames 21, the thickness E of each device 1 corresponding to the distance D between the two frames in which the device 1 is located. The length of the edges 9-1, 10-1 is preferably greater than the distance L, which enables each device 1 to act on the two hydrogen tanks 4, 5 in the event of an impact. In a variant, the length of the edges 9-1, 10-1 is equal to the diameter Di of one of the tanks, so that each device 1 is dedicated exclusively to one of the tanks 4, 5.

The flat portion 8 of each device 1 is located under and close to the tanks 4, 5, while the curved portion 7 rests on the annular contour of the frames 21. Thus, the shape of each device 1 is perfectly adapted to the profile of the aircraft 2, the curved portion 7 fitting the annular shape of the frames 21 (the curvature of the device 1 is the same as the curvature of the frames 21) and the thickness E corresponding to the center-to-center distance D between the frames 21. The flat portion 8 ensures that the device 1 is not an obstacle to the installation of the tanks 4, 5.

In FIG. 2, the protective devices 1 are installed regularly, leaving a space S between two frames 21 free of any device 1. The fact that the devices 1 are spaced apart regularly ensures uniform protection of the tanks 4, 5 in the event of an impact.

The gap in the arrangement of the devices 1 is of course not limited to this configuration. It is also possible to arrange them in each space S, or conversely to space them further apart, depending on the geometry of the fuselage, and of the tanks, in particular.

In FIG. 2, the devices 1 cover only some of the length of the tanks 4, 5. Nevertheless, the invention is not limited to this embodiment, and the devices 1 can cover the entire length of the tanks 4, 5, in order to maximize the protection of the tanks.

As shown more particularly in FIGS. 3 and 4, each filling port 12 is located between the two tanks 4, 5, which makes them accessible during maintenance, to enable the device 1 to be filled, for example by an operator, even if the tanks 4, 5 remain installed in the aircraft 2.

As also shown in FIGS. 3 and 4, the safety valves 13, 14 are arranged close to the frames 21, which makes them accessible during maintenance, for example to enable opening or closing by an operator, even if the tanks 4, 5 remain installed in the aircraft 2.

It should be noted that, depending on whether the focus is on a specific type of fire outbreak or protecting the aircraft from several types of fire, it is possible to choose whether the extinguishing agents of the devices 1 are all the same, or some are different, or the extinguishing agent of each device 1 is different.

The action of the devices 1 in the aircraft 2 is described below in the event of impact against a hard surface, denoted Su in FIG. 4, such as the ground or on water.

When the aircraft collides with the surface Su, the tanks 4, 5 move downwards against the devices 1, and the envelopes 6 thereof deform to envelop the lower portion of the tanks 4, 5. Thus, some of the energy of the impact is absorbed by the devices 1 and, simultaneously, the risk of contact against hard points is reduced, since the tanks are less likely to collide with structural elements of the aircraft 2.

When the tanks hit the devices 1, the internal pressure in the devices 1 increases until it exceeds the threshold value of the safety valves 13, 14, and the extinguishing agents are released into the compartment around the tanks 4, 5. The flow of the extinguishing agent is represented by dashed arrows in FIG. 4. As explained above, the extinguishing agents then drastically reduce the risks (during the chemical reaction forming water from the dihydrogen of the tanks, in the event of leakage, and the dioxygen of the air) and/or combustion.

If the aircraft falls into the water, then the devices 1 increase the buoyancy of the aircraft until they have been completely emptied.

As can already be seen from the description above, the devices 1 are installed empty in the fuselage 3 and then filled with extinguishing agent. The tanks 4, 5 are then placed in the fuselage 3, above the protective devices 1. Thus, the devices 1 have the advantage of occupying a space which, due to the presence of the tanks, cannot be occupied by aircraft systems.

As can already be seen from the description above, the present invention has numerous combined advantages. The devices 1 provide enhanced protection for the tanks 4, 5 by absorbing the energy of an impact, by reducing the risks of tank collisions and thus reducing the risks of hydrogen leaks. The flows of extinguishing agents released by the safety valves reduces the risk of fire by expelling dioxygen from around the tanks. Moreover, the bag-shaped devices 1 are simple, inexpensive and efficient technology, and can be installed under the tanks, which would otherwise be an unused space. Thus, the devices 1 according to the present invention are multifunctional safety bags.

Modifications and improvements to the implementations described above of the present invention may occur to a person skilled in the art. The above description is illustrative by means of examples rather than limiting. The scope of the present invention is therefore limited solely by the scope of the claims below.

The systems and devices described herein may include a controller or a computing device comprising a processing unit and a memory which has stored therein computer-executable instructions for implementing the processes described herein. The processing unit may comprise any suitable devices configured to cause a series of steps to be performed so as to implement the method such that instructions, when executed by the computing device or other programmable apparatus, may cause the functions/acts/steps specified in the methods described herein to be executed. The processing unit may comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof.

The memory may be any suitable known or other machine-readable storage medium. The memory may comprise non-transitory computer readable storage medium such as, for example, but not limited to, an electronic, magnetic, optical, electromagnetic, infrared, or semiconductor system, apparatus, or device, or any suitable combination of the foregoing. The memory may include a suitable combination of any type of computer memory that is located either internally or externally to the device such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. The memory may comprise any storage means (e.g., devices) suitable for retrievably storing the computer-executable instructions executable by processing unit.

The methods and systems described herein may be implemented in a high-level procedural or object-oriented programming or scripting language, or a combination thereof, to communicate with or assist in the operation of the controller or computing device. Alternatively, the methods and systems described herein may be implemented in assembly or machine language. The language may be a compiled or interpreted language. Program code for implementing the methods and systems described herein may be stored on the storage media or the device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein.

Computer-executable instructions may be in many forms, including modules, executed by one or more computers or other devices. Generally, modules include routines, programs, objects, components, data structures, etc., that perform particular tasks or implement particular abstract data types. Typically, the functionality of the modules may be combined or distributed as desired in various embodiments.

It will be appreciated that the systems and devices and components thereof may utilize communication through any of various network protocols such as TCP/IP, Ethernet, FTP, HTTP and the like, and/or through various wireless communication technologies such as GSM, CDMA, Wi-Fi, and WiMAX, is and the various computing devices described herein may be configured to communicate using any of these network protocols or technologies.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A device for protecting a hydrogen tank, the device comprising:
an external envelope delimiting an internal volume; and
an extinguishing agent in said internal volume,
wherein the external envelope is provided with at least one pressure relief valve to release said at extinguishing agent when a pressure prevailing in the internal volume is greater than a threshold value, and
wherein the external envelope is shaped to be installed in a fuselage of an aircraft.

2. The device according to claim 1, wherein the external envelope comprises a curved portion configured to be placed against a lower portion of the fuselage of the aircraft and to follow a contour thereof.

3. The device according to claim 1, wherein the external envelope has, when installed in the aircraft, a thickness equal to a center-to-center distance between two consecutive frames between which the protective device is installed.

4. The device according to claim 1, wherein the external envelope comprises at least one filling port for extinguishing agent.

5. The device according to claim 1, wherein the threshold pressure is between 2.5*10⁵ Pa and 5*10⁵ Pa.

6. The device according to claim 1, wherein said extinguishing agent is at a pressure between 10⁵ Pa and 2*10⁵ Pa.

7. The device according to claim 1, wherein the external envelope is made of deformable material.

8. An aircraft comprising:
a fuselage having a structure provided with a plurality of annular frames;
at least one hydrogen tank; and
the protective device according to claim 1 arranged beneath said at least one hydrogen tank, when the fuselage is in a horizontal position.

9. The aircraft according to claim 8, wherein the external envelope of the protective device has, when installed in the aircraft, a thickness equal to a center-to-center distance between two consecutive annular frames between which the protective device is installed, and
wherein the external envelope of the protective device has a curved portion which rests on at least one of the annular frames of the fuselage portion.

10. The aircraft according to claim 9, further comprising:
a second protective device arranged under the at least one hydrogen tank, when the fuselage is in the horizontal position,
the second protective device comprising
an external envelope delimiting an internal volume; and
an extinguishing agent in said internal volume,
wherein the external envelope is provided with at least one pressure relief valve to release said at extinguishing agent when a pressure prevailing in the internal volume is greater than a threshold value, and
wherein the external envelope is shaped to be installed in the fuselage of the aircraft,
wherein the extinguishing agent of the protective device being different from the extinguishing agent of the second protective device.
